(19) United States
(12) Patent Application Publication
(10) Pub. No.: US 2021/0147229 A1
(43) Pub. Date: May 20, 2021

(54) POROUS WALL REACTOR FOR GENERATING HYDROGEN AND SOLID CARBON

(71) Applicant: ExxonMobil Research and Engineering Company, Annandale, NJ (US)

(72) Inventors: Robert D. Kaminsky, Houston, TX (US); David C. Dankworth, Princeton, NJ (US)

(21) Appl. No.: 17/088,267

(22) Filed: Nov. 3, 2020

Related U.S. Application Data
(60) Provisional application No. 62/937,953, filed on Nov. 20, 2019.

(51) Int. Cl. C01B 3/36

(52) U.S. Cl. CPC C01B 3/363; C10J 2300/1646; C10J 2300/1223; C01B 2203/0811; C01B 2203/0255

(57) ABSTRACT

Apparatuses and methods are provided for generating elemental hydrogen and carbon from a hydrocarbon feed. In some examples, the apparatus can include a first tube and a second tube. The first tube can be configured to carry a hydrocarbon feed along a first flow path. The second tube can be configured to carry a fuel and an oxygen-containing gas along a second flow path, where the first flow path and second flow path are countercurrent. A porous wall can sperate the first tube from the second tube where the porous wall can be configured to allow heat and gas to pass from the second tube to the first tube.

### CROSS REFERENCE TO RELATED APPLICATIONS

This application claims priority to U. S. Provisional Application Ser. No. 62/937,953 filed Nov. 20, 2019 which is herein incorporated by reference in its entirety.

### FIELD

This invention relates to a method and apparatus to thermally decompose a hydrocarbon feed into elemental hydrogen and solid carbon. More particularly, this invention relates to using a porous wall reactor to thermally decompose a hydrocarbon feed into elemental hydrogen and solid carbon.

### BACKGROUND

Thermal decomposition of a hydrocarbon feed may have applications in the generation of hydrogen to be used as a chemical feedstock or a low greenhouse gas (GHG) fuel. Moreover, thermal decomposition of hydrocarbons may also provide a low GHG emission alternative to conventional flaring of natural gas, especially for non-emergency flaring. Thermal decomposition flaring releases much less CO₂ to the atmosphere than conventional flaring since the bulk of the atomic carbon in the feed would be converted to solid carbon rather than CO₂. The solid carbon could then be sequestered via burial or used as a filler in a stable substance (such as in cement, asphalt, or rubbers).

Although thermal decomposition of hydrocarbons is well-known chemistry, it is challenging to apply on large-scale due to the high temperatures required (e.g., >1200° C.) and rapid fouling (i.e., deposition) of reactor surfaces with generated solid carbon. Additionally, thermal decomposition reactors are energetically inefficient due to the amount of energy required to heat the hydrocarbons to the temperatures required.

There remains a need for an improved process for the thermal decomposition of hydrocarbons that can be utilized at a large-scale refinery operation that is energy efficient has reduced fouling.

### SUMMARY

In one aspect, an apparatus for generating elemental hydrogen and carbon from a hydrocarbon feed is provided. The apparatus can include a first tube and a second tube. The first tube can be configured to carry a hydrocarbon feed along a first flow path. The second tube can be configured to carry a fuel and an oxygen-containing gas along a second flow path, where the first flow path and second flow path are countercurrent. The second tube can include a mixing zone where the fuel and the oxygen-containing gas are mixed but not combusted, a combustion zone where the fuel reacts with the oxygen containing gas to form a combustion product, where the combustion zone in the second tube is downstream along the second flow path from the mixing zone of the second tube, and a combustion product cooling zone where the combustion product cools as heat is conducted from the second tube into the first tube, wherein the combustion product cooling zone in the second tube is downstream along the second flow path from the combustion zone of the second tube. A porous wall can sperate the first tube from the second tube where the porous wall can be configured to allow heat and a portion of the combustion product, fuel, oxygen containing gas, or mixtures thereof to pass from the second tube to the first tube.

In another aspect, a method for generating elemental hydrogen and carbon from a hydrocarbon feed is provided. The method can include introducing the hydrocarbon feed into a first tube along a first flow path. A fuel and an oxygen containing gas can be introduced into a second tube along a second flow path, where the first flow path and second flow path are countercurrent and a porous wall separates an interior of the first tube from an interior of the second tube. The fuel and the oxygen containing gas can be combusted in a combustion zone in the second tube. Heat can be transferred from the combustion zone in the second tube into a reaction zone in the first tube, where the hydrocarbon feed is thermally decomposed into elemental hydrogen and carbon, wherein a portion of the carbon bonds to the porous wall. A portion of the of the combustion product, the fuel, the oxygen containing gas, or mixtures thereof can flow from the second tube through the porous wall into the first tube wherein at least a portion of the combustion product, the fuel, the oxygen containing gas, or mixtures thereof react with the carbon bonded to the porous wall to debond the carbon from the porous wall.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side elevation view of a decomposition reactor, according to a first aspect of the invention.

FIG. 2 is a side elevation view of a decomposition reactor, according to a second aspect of the invention.

### DETAILED DESCRIPTION

It is to be understood that the following disclosure describes several exemplary embodiments for implementing different features, structures, and/or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the Figures. Moreover, the exemplary embodiments presented below can be combined in any combination of ways, i.e., any element from one exemplary embodiment can be used in any other exemplary embodiment, without departing from the scope of the disclosure.

One of the challenges for thermal decomposition of hydrocarbons, particularly due to the high temperatures required to efficiently operate, is buildup of carbon on the surfaces of the reactor. To remove the carbon, it may be necessary to mechanically remove the carbon from the reactor surfaces, which is challenging if the reactor remains at high temperatures. Alternatively, the carbon may be burned off the surfaces, but this prevents the carbon from being collected as a product and generates and releases considerable amounts of carbon dioxide.

Another challenge for thermal decomposition of hydrocarbons is efficiently heating the reaction. The high temperature required for thermal decomposition requires a significant amount of energy. Often, the energy used to preheat and thermally decompose the hydrocarbon feed dissipates without any further use.

It has been surprisingly and unexpectedly discovered that using two separate tubes with apertures in the wall that separates the tubes along with a countercurrent flow can both effectively manage the carbon build up on the walls in the reactor as well efficiently heat the thermal decomposition reaction.

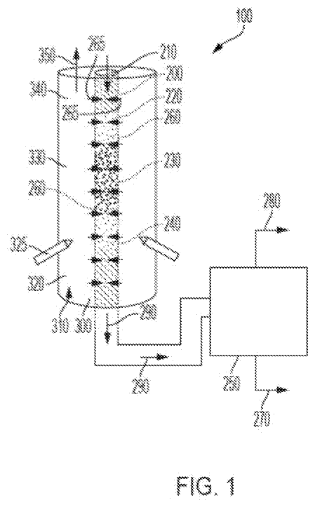

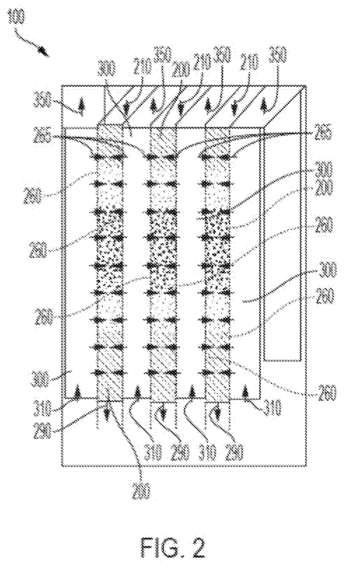

FIG. 1 and FIG. 2 depict examples of a thermal decomposition reactor 100 shown schematically. The reactor 100 can include a first tube 200 configured to carry a hydrocarbon feed along a first flow path 210 and a second tube 300 configured to carry a fuel and an oxygen containing gas along a second flow path 310. In some examples, the first tube 200 can have a preheating zone 220 where the hydrocarbon feed is heated. In some examples, the first tube 200 can have a reaction zone 230 where the hydrocarbon feed reacts to form elemental hydrogen (H2) and carbon. The reaction zone 230 can be downstream along the first flow path from the preheating zone 220. In some examples, the first tube 200 can have a decomposition product cooling zone 240 where the elemental hydrogen and carbon cool as heat is conducted from the first tube 200 into the second tube 300. The decomposition product cooling zone 240 can be downstream of the reaction zone 230. The elemental hydrogen and carbon stream 290 can exit the first tube 200. The separator 250 can be in fluid communication with the first tube 200. The separator 250 can comprise a filter, centrifugal gas/solid separator, fluid bath, or other means used to separate out solid carbon particles from the gaseous elemental hydrogen. The elemental hydrogen stream 270 and carbon stream 280 can be collected from the separator 250. In some examples, at least a portion of the elemental hydrogen can be recycled back to the second tube and used as at least a portion of the fuel used in the second tube 300. In some examples, the cross-section of the first tube 200 can be square, rectangular, semi-circular, partly-circular, elliptical, trapezoidal, parallelogram, pentagonal, hexagonal, plus-sign, or triangular.

In some examples, the second tube 300 can include a mixing zone 320 where the fuel and the oxygen-containing gas are mixed but not combusted. In some examples, the second tube 300 can include a heat source 325. The heating source 325 can be located in mixing zone 320. The heating source 325 can be used to heat a fuel and an oxygen containing gas to initiate a combustion reaction. In some examples, the heating source 325 may be at the end of a fuel inlet where the fuel is mixed with the oxygen-containing gas. The heating source 325 can be a burner tip. In some examples, the fuel can be introduced into the second tube 300 via heating source 325. In some examples, the mixing zone 320 can occur at least partially within the heating source, for example a burner tip utilizing pre-mixed combustion. In some examples, at least a portion of the elemental hydrogen collected from separator 250 can be recycled back to the second tube 300 and used as at least a portion of the fuel used in the combustion reaction. In some examples, the second tube can include a combustion zone 330 where the fuel reacts with the oxygen containing gas to form a combustion product. In some examples, the combustion zone 330 can be downstream along the second flow path 310 from the mixing zone 320. In some example, the second tube can include a combustion product cooling zone 340 where the combustion product cools as heat is conducted from the second tube 300 into the first tube 200. In some examples, the combustion product cooling zone 340 can be downstream along the second flow path 310 of the combustion zone 330. In some examples, at least a portion of the combustion product, which can include the reaction products of the fuel and the oxygen-containing gas and any unreacted fuel or oxygen-containing gas, can exit the second tube through stream 350. In some examples, the cross-section of the second tube 300 can be square, rectangular, semi-circular, partly-circular, elliptical, trapezoidal, parallelogram, pentagonal, hexagonal, plus-sign, or triangular.

In some examples, wall 260 separates the first tube 200 from the second tube 300. Wall 260 can be porous. In some examples, porous wall 260 can be constructed from a material capable of withstanding high temperatures. In some examples, wall 260 can be constructed from ceramics, brick, sintered refractor material, or a combination thereof. The permeability of wall 260 between the first tube 200 and second tube 300 can be at least 0.0001 darcy, at least 0.001, at least 0.01, at least 0.1 darcy, at least 0.5 darcy, at least 1 darcy, at least 5 darcy, at least 10 darcy, or at least 15 darcy. The permeability of wall 260 between the first tube 200 and second tube 300 can be from about 0.1 darcy to about 15 darcy, from about 0.1 darcy to about 10 darcy, from about 0.1 darcy to about 5 darcy, from about 0.1 darcy to about 1 darcy, from about 1 darcy to about 15 darcy, from about 1 darcy to about 10 darcy, or from about 1 darcy to about 5 darcy. The permeability of wall 260 between the first tube 200 and second tube 300 can be less than 0.1 darcy, less than 0.5 darcy, less than 1 darcy, less than 5 darcy, less than 10 darcy, or less than 15 darcy. In some examples, the permeability of wall 260 between the first tube 200 and second tube 300 can be measured using ASTM D6539-13 (Standard Test Method for Measurement of the Permeability of Unsaturated Porous Materials by Flowing Air) or ASTM standard is D4525-90 (Standard Test Method for Permeability of Rocks by Flowing Air). In some examples, the permeability of wall 260 between the first tube 200 and second tube 300 can be such that at an operating pressure a portion of the of the combustion product, fuel, oxygen containing gas, or mixtures thereof can pass from the second tube to the first tube via flow path 265 where the weight of that portion of combustion product, fuel, oxygen containing gas, or mixtures thereof can be at least 0.01%, at least 0.1%, or at least 1% of the total weight of fuel and oxygen containing gas added to the second tube. In some examples, the permeability of wall 260 between the first tube 200 and second tube 300 can be such that at an operating pressure a portion of the of the combustion product, fuel, oxygen containing gas, or mixtures thereof can pass from the second tube to the first tube where the weight of that portion of combustion product, fuel, oxygen containing gas, or mixtures thereof can be less than 3% less than 1%, or less than 0.1% of the total weight of fuel and oxygen containing gas added to the second tube. In some examples, the permeability of wall 260 between the first tube 200 and second tube 300 can be such that at an operating pressure a portion of the of the combustion product, fuel, oxygen containing gas, or mixtures thereof can pass from the second tube to the first tube where the weight of that portion of combustion product, fuel, oxygen containing gas, or mixtures thereof can be from 0.01% to 3%, from 0.1% to 3%, or from 1% to 3% of the total weight of fuel and oxygen containing gas added to the second tube.

As shown in FIG. 1, the first tube 200 can be located entirely within the second tube 300. In this example, wall 260 is the entire wall of the first tube 200. However, additional embodiments that support countercurrent flow can also be used. For example, as shown in FIG. 2, a series of plate-like flow paths can be used where the first flow paths 210 and second flow path 310 alternate. In this example, porous wall 260 is shared by the first tube 200 and second tube 300. In some examples, the initial tube and the last tube in the series of tubes with plate-like flow paths can be second tubes 200 so that each first tube 200 can share at least two walls with second tubes 300. A set of plate-like flow paths may enable a more compact design for a given throughput of gas. Moreover, a set of multiple plate-like flow paths (for example >10, >20, or >50) can minimize the amount of external area to total volume and hence be more energy efficient in terms of conductive heat loss to the surroundings.

In some examples, the hydrocarbon feed can be introduced into the first tube 200 along the first flow path 210. In some examples, the hydrocarbon feed can contain methane, ethane, propane, butane, or mixtures thereof. In some examples, the hydrocarbon feed can be methane, natural gas, petroleum oils, coal tars, or mixtures thereof. The hydrocarbon feed can be either liquid or gas. In some examples, liquid hydrocarbon feeds can be vaporized or atomized for use in the reactor 100. In some examples, the hydrocarbon feed can be natural gas that would have been flared in a flare stack. This alternative to flaring may be particularly appealing for reducing CO₂, and hence greenhouse, emissions from flaring of natural gas associated with petroleum production when gas pipelines are not available for export. A large fraction of the carbon in the otherwise flared natural gas can be decomposed into solid carbon, which can be readily trucked away for disposal or sale. Moreover, co-generated hydrogen from the decomposition can be used as a local fuel (e.g., for power generation or fuel trucks) or be flared without generating any greenhouse emissions.

Fuel and an oxygen containing gas can be introduced into the second tube 300 along the second flow path 310. In some examples, the oxygen containing gas can be air, oxygen, or a mixture thereof. The first flow path 210 and second flow path 310 can be countercurrent. The porous wall 260 can separate the interior of the first tube 200 from the interior of the second tube 300 and allow gas and heat to travel between the second tube 300 and first tube 200. The fuel and the oxygen containing gas can be combusted in the combustion zone 330 of the second tube 300. The exothermic combustion reaction generates heat, which can be transferred into the reaction zone 230. The temperature in the reaction zone 230 of the first tube 200 can be at least 1000° C., at least 1100° C., at least 1200° C., at least 1300° C., at least 1400° C., or at least 1500° C. The temperature in the reaction zone 230 of the first tube 200 can be from about 1000° C. to about 2000° C., about 1100° C. to about 1900° C., about 1100° C. to about 1700° C., about 1100° C. to about 1500° C., or about 1100° C. to about 1300° C. The temperature in the reaction zone 230 can be a temperature where the hydrocarbon feed can thermally decompose into elemental hydrogen and carbon. A portion of the carbon that is created in the thermal decomposition reaction can bond to the porous wall 260. To remove the carbon that is bonded to the porous wall 260, gas can be flowed through the porous wall 260 to react with carbon bonded to the porous wall 260. The gas, which is a reactant, flowed through the porous wall 260 can migrate to the backside of the carbon deposits on the porous walls in the decomposition flow path. The gas reactant can then gasify the layer of solid carbon immediately adhering to the wall and thus cause the remaining solid carbon to detach and flow out of the reactor. The gas reactant flow through porous wall 260 is controlled to be sufficient to cause the deposited carbon to reliably and near-completely detach yet not so great as to convert all the deposit carbon to gas, particularly CO₂ which might then need to be vented, or to convert a significant fraction of the hydrogen to lower value products (e.g., water). Gas can flow through porous wall 260 from the second tube 300 to the first tube 200 when the pressure in the second tube 300 is greater than the pressure in the first tube 100. In some examples, the pressure in the second tube 300 can be at least 105%, 110%, or 120% of the pressure in the first tube 200. The reaction between the gas that flows from the second tube 300 into the first tube 200 and the attached carbon can gasify a portion of the attached carbon and can debond the attached carbon from the porous wall 260. In some examples, the gas flowed through the porous wall 260 from the second tube 300 can be an oxygen containing gas, CO₂, or steam. In some examples, the gas can be excess oxygen containing gas that is not consumed in the combustion reaction.

In some examples, the size of the carbon particles collected can be controlled by adjusting the flow of the gas through the porous wall 260. Gas can be fed through porous wall 260 at a rate sufficient to debond at least 50 wt. %, at least 60 wt. %, at least 70 wt. %, at least 80 wt. %, at least 90 wt. %, at least 95 wt. %, at least 99 wt. % of the carbon bonded to the porous wall 260. Reducing the flow rate of the gas through the porous wall 260 can allow additional carbon to bond to the porous wall 260. When the flow rate is then increased, the additional carbon can debond from the porous wall 260 and the size of the collected carbon can be increased. By adjusting the time of the reduced flow rate, the size of the collected carbon can be controlled. The size, shape, and amount of the solid carbon particles being captured may be controlled by the flow of gas reactant through the porous wall 260. In some examples, the rate of flow through porous wall 260 may be cycled between a higher and a lower rate to allow solid carbon to build-up to a desired thickness before detaching it. By allowing the solid carbon to build-up somewhat prior to detaching can promote the generation of flake-like carbon particles rather than microparticles (e.g., dust), which are more challenging to separate out from the flow and then subsequently handle and ship offsite. In some examples, the flow rate of gas from the second tube 300 to the first tube 200 through the porous wall 260 can be controlled by adjusting the difference between the pressure in the second tube 300 and the first tube 200. When the pressure in the second tube 300 is greater than the pressure in the first tube 200, gas will flow from the second tube 300 to the first tube 200 through the porous wall 260. Under these conditions, when the flow rate of the gases into the second tube 300 is increased, the flow rate of the gas through the porous wall 260 from the second tube 300 to the first tube 200 is increased. When the flow rate of the gases into the second tube 300 is decreased, the flow rate of the gas through the porous wall 260 from the second tube 300 to the first tube 200 is decreased. Similarly, when the flow rate of the gases into the first tube 200 is increased, the flow rate of the gas through the porous wall 260 from the second tube 300 to the first tube 200 is decreased. When the flow rate of the gases into the first tube 200 is decreased, the flow rate of the gas through the porous wall 260 from the second tube 300 to the first tube 200 is increased.

Additionally, the concentration of the gas that reacts with the bonded carbon can be adjusted to control the amount of carbon that is debonded from the porous wall 260. In some examples, the concentration of oxygen in the oxygen containing gas that is introduced into the second tube 300 can be adjusted to change the amount of carbon that is debonded to the porous wall 260. Increasing the concentration of oxygen in the oxygen containing gas can increase the amount of carbon that is debonded to the porous wall 260 by increasing the amount of oxygen available to react with the attached carbon. Similarly, decreasing the concentration of oxygen in the oxygen containing gas can decrease the amount of carbon that is debonded to the porous wall 260 by making less oxygen available to react with the attached carbon. By adjusting the amount of time at the different oxygen concentrations, the size of the collected carbon can be controlled.

The average diameter of the carbon particles on a mass-weighted basis that are collected from the reactor 100 can be less than 10 mm, 1 mm, or 0.1 mm. The average diameter of the carbon particles that are collected from the reactor 100 can be greater than 0.1 mm, 1 mm, or 10 mm. The average size of the carbon particles that are collected from the reactor 100 can be from 0.1 mm to 1 mm, 0.1 to 10 mm, or 1 mm to 10 mm.

Embodiment 1. An apparatus comprising: a first tube configured to carry a hydrocarbon feed along a first flow path; a second tube configured to carry a fuel and an oxygen-containing gas along a second flow path, the first flow path and second flow path being countercurrent, wherein the second tube comprises: a mixing zone where the fuel and the oxygen-containing gas are mixed but not combusted, a combustion zone where the fuel reacts with the oxygen containing gas to form a combustion product, the combustion zone in the second tube being downstream along the second flow path from the mixing zone of the second tube, and a combustion product cooling zone where the combustion product cools as heat is conducted from the second tube into the first tube, the combustion product cooling zone in the second tube being downstream along the second flow path from the combustion zone of the second tube; and a porous wall separating the first tube from the second tube, the porous wall optionally having a permeability between 0.0001 darcy and 15 darcy, wherein the porous wall is configured to allow heat and a portion of the combustion product, fuel, oxygen containing gas, or mixtures thereof to pass from the second tube to the first tube, a cross-section of the first tubes and/or the second tube optionally being circular or rectangular.

Embodiment 2. The apparatus of Embodiment 1, further comprising a heat source in the mixing zone of the second tube, the heat source optionally causing combustion between the fuel and the oxygen-containing gas, the heat source optionally comprising a burner tip.

Embodiment 3. The apparatus of any of Embodiments 1 to 2, further comprising a further comprising a gas-solid separator in fluid communication with the first tube, a separated gas recovered from the gas-solid separator optionally comprising at least a portion of the fuel.

Embodiment 4. The apparatus of any of Embodiments 1 to 3, wherein a second tube pressure measured in the second tube at a first aperture in the porous wall is greater than a first tube pressure measured in the first tube at the first aperture in the porous wall.

Embodiment 5. The apparatus of any of Embodiments 1 to 4, wherein the first tube is inside the second tube, or wherein the first tube is adjacent to the second tube.

Embodiment 6. The apparatus of any of Embodiments 1 to 5, wherein the first tube comprises, a preheating zone where the hydrocarbon feed is heated, a reaction zone where the hydrocarbon feed reacts to form elemental hydrogen and carbon, wherein the reaction zone in the first tube is downstream along the first flow path from the preheating zone in the first tube, and a product cooling zone where the hydrogen and carbon cool as heat is conducted from the first tube into the second tube, wherein the product cooling zone in the first tube is downstream along the first flow path of the reaction zone in the first tube.

Embodiment 7. A method for generating elemental hydrogen and carbon from a hydrocarbon feed comprising: introducing the hydrocarbon feed into a first tube along a first flow path; introducing a fuel and an oxygen-containing gas into a second tube along a second flow path, the first flow path and second flow path being countercurrent, a porous wall separating an interior of the first tube from an interior of the second tube, the porous wall optionally comprising a permeability of between 0.0001 darcy and 15 darcy; combusting the fuel and the oxygen-containing gas in a combustion zone in the second tube; transferring heat from the combustion zone in the second tube into a reaction zone in the first tube, the hydrocarbon feed being thermally decomposed into elemental hydrogen and carbon in the reaction zone, a portion of the carbon bonding to the porous wall; and flowing a portion of the of the combustion product, the fuel, the oxygen-containing gas, or mixtures thereof from the second tube through the porous wall into the first tube, wherein at least a portion of the combustion product, the fuel, the oxygen-containing gas, or mixtures thereof react with the carbon bonded to the porous wall to debond the carbon from the porous wall, a temperature of the reaction zone optionally being from 1000° C. to 1500° C.

Embodiment 8. The method of Embodiment 7, further comprising controlling a rate of flow of the combustion product, the fuel, the oxygen-containing gas, or mixtures thereof from the second tube to first tube.

Embodiment 9. The method of Embodiment 8, wherein the rate of flow of the combustion product, the fuel, the oxygen-containing gas, or mixtures thereof from the second tube to the first tube is controlled by adjusting a flow pressure of the hydrocarbon stream, adjusting a flow pressure of the oxygen-containing gas, or adjusting an oxygen content of the oxygen-containing gas.

Embodiment 10. The method of Embodiment 8 or 9, wherein the rate of flow of the combustion product, the fuel, the oxygen-containing gas, or mixtures thereof from the second to first flow path is controlled to control a physical dimension of the carbon debonded from the porous wall.

Embodiment 11. The method of any of Embodiments 7 to 10, wherein the fuel comprises at least a portion of the elemental hydrogen, or wherein at least a portion of the elemental hydrogen is flared, or a combination thereof.

Embodiment 12. The method of any of Embodiments 7 to 11, further comprising separating the carbon from the elemental hydrogen.

Embodiment 13. The method of any of Embodiments 7 to 12, a) wherein the carbon comprises carbon black, graphite, or coke; b) wherein the hydrocarbon feed comprises natural gas; c) wherein the oxygen-containing gas comprises air; or d) a combination of two or more of a), b), and c).

Embodiment 14. The method of any of Embodiments 7 to 13, wherein the portion of the of the combustion product, the fuel, the oxygen-containing gas, or mixtures thereof that pass from the second tube to the first tube has a weight that is less than 3% of a total weight of fuel and oxygen-containing gas added to the second tube.

Embodiment 15. The method of any of Embodiments 7 to 14, wherein a second tube pressure measured in the second tube at a first aperture in the porous wall is greater than a first tube pressure measured in the first tube at the first aperture in the porous wall.

Supplemental Embodiment A. The apparatus of any of Embodiments 1 to 6 or the method of any of Embodiments 7 to 15, wherein the porous wall comprises a porous ceramic material, a porous brick, or a porous sintered refractory metal.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. An apparatus comprising:
a first tube configured to carry a hydrocarbon feed along a first flow path;
a second tube configured to carry a fuel and an oxygen-containing gas along a second flow path, the first flow path and second flow path being countercurrent,
wherein the second tube comprises:
a mixing zone where the fuel and the oxygen-containing gas are mixed but not combusted,
a combustion zone where the fuel reacts with the oxygen-containing gas to form a combustion product, wherein the combustion zone in the second tube is downstream along the second flow path from the mixing zone of the second tube, and
a combustion product cooling zone where the combustion product cools as heat is conducted from the second tube into the first tube, wherein the combustion product cooling zone in the second tube is downstream along the second flow path from the combustion zone of the second tube; and
a porous wall separating the first tube from the second tube wherein the porous wall is configured to allow heat and a portion of the combustion product, fuel, oxygen-containing gas, or mixtures thereof to pass from the second tube to the first tube.

2. The apparatus of claim 1, further comprising a heat source in the mixing zone of the second tube.

3. The method of claim 2, wherein the heat source comprises a burner tip.

4. The apparatus of claim 1, further comprising a gas-solid separator in fluid communication with the first tube.

5. The apparatus of claim 1, wherein a cross-section of the first tube or second tube is circular or rectangular.

6. The apparatus of claim 1, wherein the hydrocarbon feed is methane, wherein the oxygen-containing gas is ambient air, or a combination thereof.

7. The apparatus of claim 1, wherein the first tube is inside the second tube.

8. The apparatus of claim 1, wherein the first tube is adjacent to the second tube.

9. The apparatus of claim 1, wherein the porous wall has a permeability between 0.0001 darcy and 15 darcy.

10. The apparatus of claim 1, wherein the first tube comprises,
a preheating zone where the hydrocarbon feed is heated,
a reaction zone where the hydrocarbon feed reacts to form elemental hydrogen and carbon, wherein the reaction zone in the first tube is downstream along the first flow path from the preheating zone in the first tube, and
a product cooling zone where the hydrogen and carbon cool as heat is conducted from the first tube into the second tube, wherein the product cooling zone in the first tube is downstream along the first flow path of the reaction zone in the first tube.

11. A method for generating elemental hydrogen and carbon from a hydrocarbon feed comprising:
introducing the hydrocarbon feed into a first tube along a first flow path,
introducing a fuel and an oxygen-containing gas into a second tube along a second flow path, the first flow path and second flow path being countercurrent, a porous wall separating an interior of the first tube from an interior of the second tube,
combusting the fuel and the oxygen-containing gas in a combustion zone in the second tube,
transferring heat from the combustion zone in the second tube into a reaction zone in the first tube, the hydrocarbon feed being thermally decomposed into elemental hydrogen and carbon in the reaction zone, a portion of the carbon bonding to the porous wall, and
flowing a portion of the of the combustion product, the fuel, the oxygen-containing gas, or mixtures thereof from the second tube through the porous wall into the first tube wherein at least a portion of the combustion product, the fuel, the oxygen-containing gas, or mixtures thereof react with the carbon bonded to the porous wall to debond the carbon from the porous wall.

12. The method of claim 11, further comprising controlling a rate of flow of the combustion product, the fuel, the oxygen-containing gas, or mixtures thereof from the second tube to first tube.

13. The method of claim 12, wherein the rate of flow of the combustion product, the fuel, the oxygen-containing gas, or mixtures thereof from the second tube to the first tube is controlled by adjusting a flow pressure of the hydrocarbon stream, adjusting a flow pressure of the oxygen-containing gas, or adjusting an oxygen content of the oxygen-containing gas.

14. The method of claim 12, wherein the rate of flow of the combustion product, the fuel, the oxygen-containing gas, or mixtures thereof from the second to first flow path is controlled to control a physical dimension of the carbon debonded from the porous wall.

15. The method of claim 11, wherein a temperature of the reaction zone is from 1000° C. to 1500° C.

16. The method of claim 11, wherein the fuel comprises at least a portion of the produced elemental hydrogen.

17. The method of claim 11, further comprising separating the carbon from the elemental hydrogen.

18. The method of claim 11, wherein the carbon comprises carbon black, graphite, or coke.

19. The method of claim 11, wherein the hydrocarbon feed comprises natural gas, or wherein the oxygen-containing gas comprises air, or a combination thereof.

20. The method of claim 11, wherein at least a portion of the generated elemental hydrogen is flared.

21. The method of claim 11, wherein the porous wall has a permeability of between 0.0001 darcy and 15 darcy.

22. The method of claim 11, wherein the portion of the of the combustion product, the fuel, the oxygen-containing gas, or mixtures thereof that pass from the second tube to the first tube has a weight that is less than 3% of a total weight of fuel and oxygen-containing gas added to the second tube.

23. The method of claim 11, wherein the porous wall comprises a porous ceramic material, a porous brick, or a porous sintered refractory metal.

24. The method of claim 11, wherein a second tube pressure measured in the second tube at a first aperture in the porous wall is greater than a first tube pressure measured in the first tube at the first aperture in the porous wall.
